(19) United States
(12) Patent Application Publication
(10) Pub. No.: US 2020/0274986 A1
(43) Pub. Date: Aug. 27, 2020

(54) SCAN ASSEMBLY FRAME

(71) Applicant: Hewlett-Packard Development Company, L.P., Houston, TX (US)

(72) Inventors: Kevin Lo, Vancouver, WA (US); Wade Nylund, Vancouver, WA (US)

(21) Appl. No.: 16/066,132

(22) PCT Filed: Apr. 27, 2016
(86) PCT No.: PCT/US2016/029488

§ 371 Date: Jun. 26, 2018

(51) Int. Cl. H04N 1/31; H04N 1/028

(52) U.S. Cl. CPC H04N 1/31; H04N 1/028

(57) ABSTRACT

A scan assembly comprises a monolithic metal frame having an outer wall defining an interior frame portion. The interior frame portion has a scan region to support and at least partially house a scan unit to be movable within and relative to the scan region and has a control region to support and at least partially house a control panel. The outer wall has a first face exposed to the interior frame portion and an opposite second face to be directly exposed to an external environment.

### BACKGROUND

Multi-function imaging devices are nearly ubiquitous in both home and office environments. Via such imaging devices, people's productivity in consuming and producing information has soared.

### BRIEF DESCRIPTION OF THE DRAWINGS

FIG. 1 is a block diagram schematically representing a scan assembly, according to one example of the present disclosure.

FIG. 2 is a diagram schematically representing a multi-function imaging device, according to one example of the present disclosure.

FIG. 3A is a top view schematically representing a scan assembly, according to one example of the present disclosure.

FIG. 3B is a diagram schematically representing a scan assembly according to a sectional view of FIG. 3A as taken along lines 3B-3B, according to one example of the present disclosure.

FIG. 3C is a partial sectional view schematically representing a portion of the scan assembly of FIG. 3A incorporating a scan surface, according to one example of the present disclosure.

FIG. 3D a partial perspective view schematically representing a control region of the scan assembly of FIG. 3A with a control panel pivoted into an upright position, according to one example of the present disclosure.

FIG. 4 is a perspective view schematically representing a scan assembly frame, according to one example of the present disclosure.

FIG. 5 is a sectional view of the scan assembly frame of FIG. 4 as taken along lines 5-5, according to one example of the present disclosure.

FIG. 6 is a sectional view of the scan assembly frame of FIG. 4 as taken along lines 6-6, according to one example of the present disclosure.

FIG. 7 is an end view of the scan assembly frame of FIG. 4 as taken along lines 7-7, according to one example of the present disclosure.

FIG. 8 is a diagram schematically representing a multi-function imaging device, according to one example of the present disclosure.

FIG. 9 is a diagram schematically representing a scan assembly, according to one example of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

At least some examples of the present disclosure are directed to a scan assembly comprising a monolithic metal frame having an outer wall defining an interior frame portion. The interior frame portion has a scan region to support and at least partially house a scanning unit to be movable within and relative to the scan region. The interior frame portion also has a control region to support and at least partially house a control panel. The outer wall has a first face exposed to the interior frame portion and an opposite second face to be directly exposed to an external environment.

In some examples, adjacent at least the scan region, a height of the outer wall extends in a first orientation and at least a majority of the scan region extends in a second orientation generally perpendicular to the first orientation.

In some examples, the scan assembly may sometimes be referred to as a scan tub. In some examples, the scan assembly may be incorporated into a multi-function printer or other imaging device. In one aspect, the monolithic frame has a low profile in a vertical orientation of an imaging device while exhibiting torsional stiffness and mass, which reduces vibration and/or noise to enhance quiet scanning. Meanwhile, this low profile in the vertical orientation may enable compliance with Section 508 of American Disabilities Act (ADA) via achieving a lower overall height of the imaging device, whether as a desktop model or floor-standing model. In addition, the single piece metal frame provides strength to withstand large loads during handling and/or robust use.

Some commercially available scan tubs typically have multiple parts connected together, have a separate control panel frame and/or are made of plastic. In addition to a less elegant appearance, these arrangements lack the strength, stability, and/or low profile offered by at least some examples of the present disclosure.

As noted above, in some examples the scan assembly includes a scan region to support and at least partially house a scanning unit to be movable within and relative to the scan region. As previously noted, in some examples an outer wall of the metal frame of the scan assembly is exposed to an external environment. This arrangement may reduce manufacturing costs, while enhancing aesthetics.

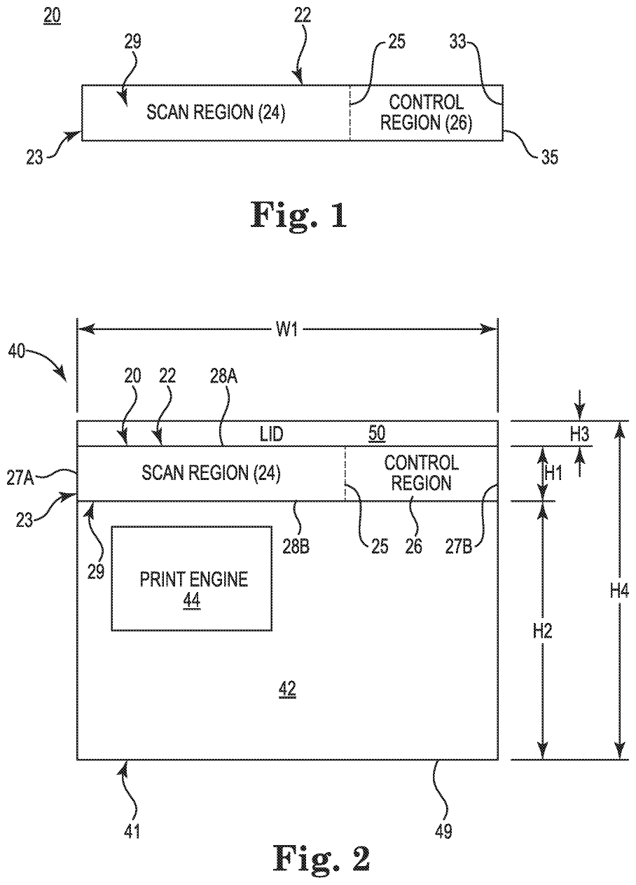

These examples, and additional examples, are described in association with at least FIGS. 1-9.

FIG. 1 is a block diagram schematically representing a scan assembly 20, according to one example of the present disclosure. As shown in FIG. 1, the scan assembly 20 comprises a metal frame 22 having an outer wall 23, which defines an interior frame portion 29 having a scan region 24 and a control region 26. Dashed lines 25 indicate a transition between the scan region 24 and control region 26, as further illustrated later in at least FIG. 2. However, in some examples, outer wall 23 defines a seamless construction such that dashed lines 25 do not indicate or imply any seams in outer wall 23.

As further shown in FIG. 1, the outer wall 23 includes a first face 33 exposed to the interior frame portion 29 and an opposite second face 35 to be directly exposed to an external environment.

FIG. 2 is a diagram schematically representing a multi-function imaging device 40, according to one example of the present disclosure. As shown in FIG. 2, outer wall 23 of frame 22 defines a top edge 28A and an opposite bottom edge 28B, as well as first side 27A and opposite second side 27B.

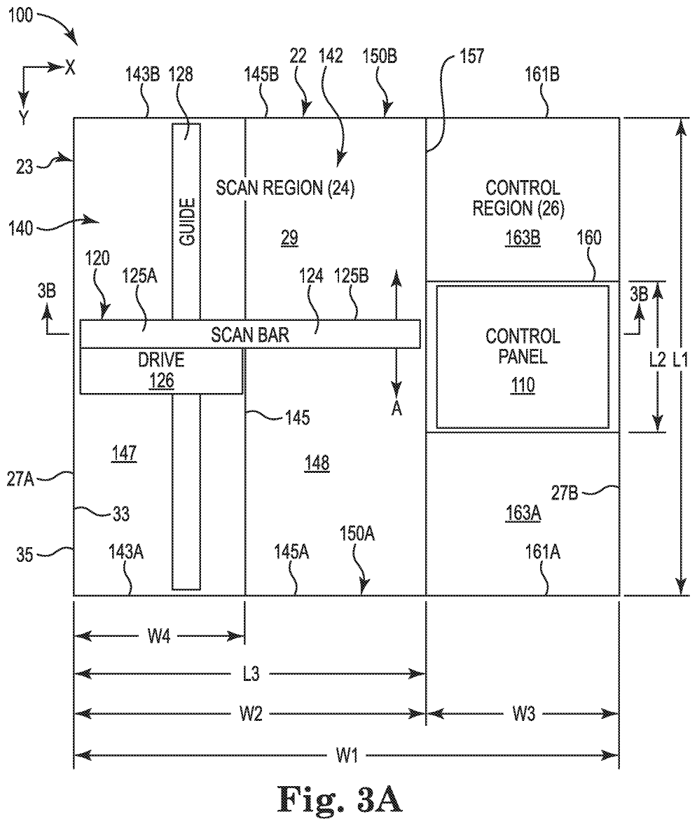

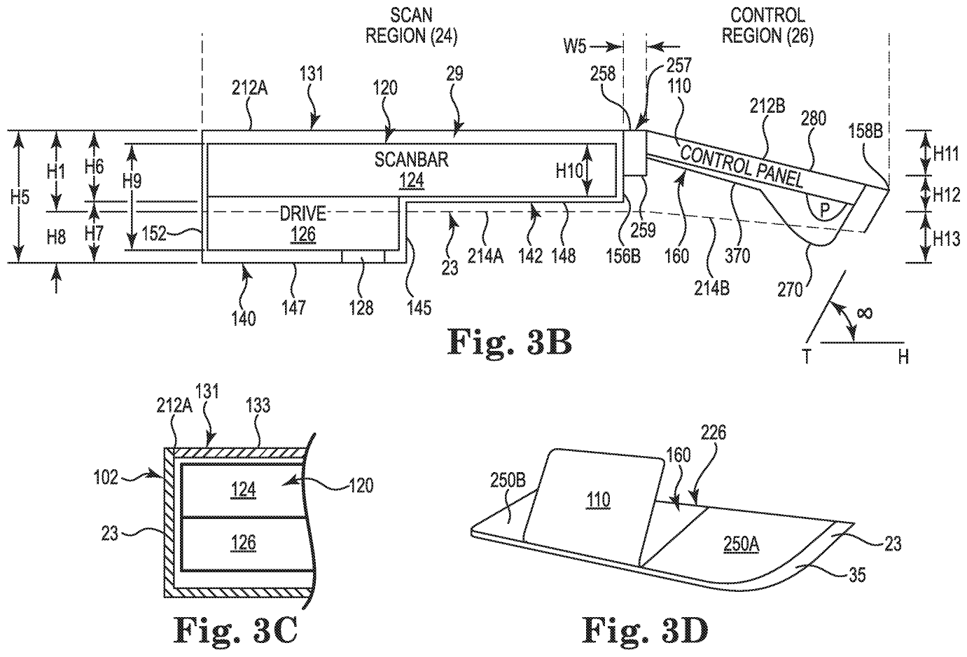

As shown in FIG. 2, the imaging device 40 incorporates the scan assembly 20, and further includes a print portion 41 and a lid 50. The print portion 41 includes a frame 42 at least partially housing a print engine 44 and supporting the scan assembly frame 22 of scan assembly 20. In one aspect, the print portion 41 is disposed vertically below, and coupled to, the scan assembly frame 22. In another aspect, the lid 50 is disposed vertically above, and coupled to, the scan assembly frame 22 with lid 50 being pivotally movable relative to the scan assembly frame 22 to provide selective access to the scan assembly 20. While not shown in FIG. 2 for illustrative simplicity, in some examples, lid 50 may be enhanced to incorporate an automatic document feeder (ADF) to feed documents relative to scan assembly 20 for scanning. The lid 50 is separate and distinct from a scan surface 131, which is described later in association with at least FIG. 3C. The lid 50 has a height H3.

In some examples, at least the outer wall 23 of scan assembly frame 22 has a height (H1) while the printer frame 42 has a height (H2) relative to a bottom portion 49, which is provided for contact against a support surface. In some examples, the support surface may be a desktop while in some examples, the support surface comprises a cabinet to enable a floor standing arrangement for imaging device 40.

In some examples, together the scan assembly frame 22, the second frame 42, and lid 50 have a combined height of H4 inches and the scan assembly frame 22 has a width W1. In some examples, the low vertical profile of the scan assembly frame 22 may enable the overall height (H4) of the imaging device 40 to comply with user access specifications according to standards of the American Disabilities Act (ADA), such as but not limited to, standards identified in Section 508 of the ADA.

In some examples, the scan assembly frame 22 is made of aluminum and/or aluminum alloys while in some examples, the metal scan assembly frame 22 is made from other lightweight, strong, formable metal material(s). In some examples, the scan assembly frame 22 is made of other lightweight, strong non-metal materials that are moldable or formable as a single, unitary piece.

FIG. 3A is a top view schematically representing a scan assembly 100, according to one example of the present disclosure. In some examples, scan assembly 100 comprises at least some of substantially the same features and attributes as scan assembly 20 in FIGS. 1-2 with like reference numerals referring to like elements. As shown in FIG. 3A, scan assembly 100 includes monolithic frame 22 defining interior frame portion 29, which has scan region 24 and control region 26 arranged in a side-by-side relationship. The scan region 24 comprises a first recessed portion 140 and a second recessed portion 142 arranged in a side-by-side relationship with a boundary 145 between the respective portions 140, 142. The scan region 24 at least partially houses, and supports, a scan unit 120. The scan unit 120 is selectively movable in a back-and-forth motion as represented via directional arrow A along a first orientation (Y). The control region 26 at least partially houses and supports a control panel 110.

In some examples, both the first recessed portion 140 and the second recessed portion have a length substantially the same as length L1 of the scan assembly frame 22. As further shown in FIG. 2, in some examples, the second recessed portion 142 is adjacent to the control region 26 and is interposed between the first recessed portion 140 and the control region 26. A border 157 defines a boundary or transition between second recessed portion 142 and control region 26.

In some examples, the scan unit 120 comprises a drive unit 126, a scanbar 124, and a guide 128. In some examples, the scan unit 120 comprises and/or incorporates a contact image sensor (CIS) to implement scanning functions to obtain a scanned image of an object or document placed onto a scan surface 131 above scan region 24.

In some examples, scan assembly 100 includes a scan surface 131 covering scan region 24, as schematically represented in the partial sectional view of FIG. 3C. The scan surface 131 can comprise a transparent element separate from the scan assembly frame 22 to allow the transmission of light and capturing an image via scan unit 120 through the scan surface 131 upon positioning the object or document on scan surface 131. As represented by FIGS. 3A and 3C, a top face 133 of scan surface 131 is mounted relative to scan assembly frame 22 such that face 133 of scan surface 131 is generally flush-mounted with (e.g. generally parallel to) a top edge 212A of outer wall 23 of scan assembly frame 22.

The guide 128 has a length that extends in the first orientation (Y) and which is substantially the same as the length L1 of the scan region 22. The scanbar 124 extends in a second orientation X generally perpendicular to the first orientation Y and generally perpendicular to a longitudinal axis of the guide 128. In some examples, the scan bar 124 has a length L3 which is substantially the same as or slightly less than a width W2 of the scan region 24. The drive unit 126 has a length generally corresponding to a width W4 of the first recessed portion 140 of scan region 22. Meanwhile, control region 26 has a width W3.

The drive unit 126 is sized and shaped to fit within the first recessed portion 140 and therefore to be at least partially housed within the first recessed portion 140, as further later illustrated in association with at least FIG. 3B. The drive unit 126 includes a drive mechanism engaged relative to the guide 128 to cause selective movement of the drive unit 126 and scan bar 124 in the first orientation Y as previously noted. The guide 128 is supported on, and extends, along the length L1 of the first recessed portion 140.

In some examples, in at least the scan region, the outer wall 23 defines a side portion 27A of the scan assembly frame 22 and the outer wall 23 defines two opposite ends 150A, 150B of the scan assembly frame 22. In some instances, the side 27A of the scan assembly frame 22 also may referred to as a back portion of an imaging device 40 when the control panel 110 is referred to as being located at a front portion of the imaging device 40.

In one aspect, the two opposite ends 150A, 150B of scan assembly frame 22 define end walls of scan region 24, while the side 27A of scan assembly frame 22 defines a first side wall of scan region 24. In one aspect, a combination of the side 27A of outer wall 23, of portions 143A, 143B of outer wall 23 (partially defining the ends 150A, 150B of scan region 24), and of a first bottom panel 147 at least partially defines the first recessed portion 140 of the scan region 22, as shown in FIG. 3A.

In one aspect, a combination of the boundary 145, of portions 145A, 145B of outer wall 23 (partially defining the ends 150A, 150B of scan region 24), and of a second bottom panel 148 at least partially defines the second recessed portion 142 of the scan region 22, as shown in FIG. 3A.

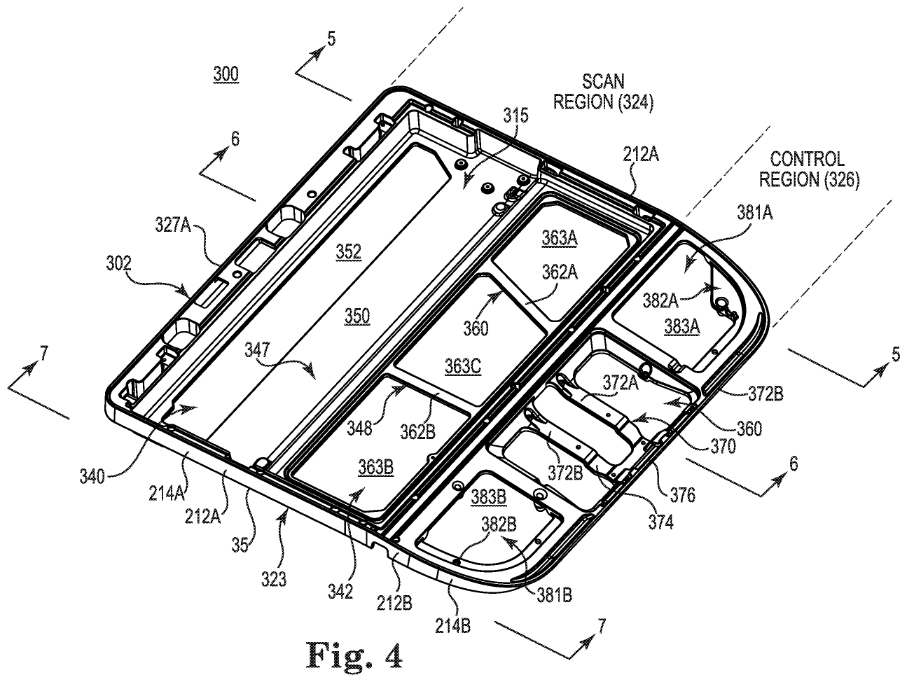

In some examples, control region 26 includes a third recessed portion 160. In some examples, the third recessed portion 160 is centered relative to opposite ends 161A, 161B of the control region 26, and therefore corresponds to a central portion of the control region 26. In some examples, the third recessed portion 160 has a length (L2) less than one-half of a length (L1) of the control region. In some examples, a control panel 110 is mountable within and relative to the third recessed portion 160 to be sandwiched between two outer portions 163A, 163B on opposite sides of control panel 110. In some examples, the two outer portions 163A, 163B have recessed structures (e.g. a ledge 382A in FIG. 4) to support respective covers 250A, 250B as shown in FIG. 3D such that a top surface of the covers 250A, 250B may be flush with a top surface of the control panel 110, in at least some examples. As further shown in FIG. 3D, in some examples the control panel 110 is pivotally mounted relative to the control region 26 to be selectively movable into an upright position relative to the third recessed portion 160 and relative to covers 250A, 250B.

FIG. 3B is a diagram schematically representing a scan assembly according to a sectional view of FIG. 3A as taken along lines 3B-3B, according to one example of the present disclosure. As shown in FIG. 3B, the first recessed portion 140 of scan assembly 100 has a depth H5 and second recessed portion 142 of scan assembly 100 has a depth H6. In one aspect, a first recessed portion 140 exceeds a depth H6 of the second recessed portion 142 by a distance H7.

A vertical wall defines boundary 145 between the first and second recessed portions 140, 142. The depth H5 of the first recessed portion 140 is equal to or greater than a combined height H9 of the drive unit 126 and scan bar 124, while the depth H6 of the second recessed portion 142 is equal to or greater than a height (H10) of the scan bar 142. Accordingly, in some examples, the first recessed portion 140 at least partially houses the drive unit 126 and a first portion 125A (FIG. 3A) of scan bar 124 while the second recessed portion 142 at least partially houses a second portion 125B (FIG. 3A) of the scan bar 124.

As further shown in FIG. 3B, the first recessed portion 140 has a first bottom panel 147, wherein the first recessed portion 140 has a first depth H5 relative to a top edge 212A of the outer wall 23 (in at least the scan region) that is greater than a second depth H6 of the second recessed portion 142. Accordingly, in one aspect, the first recessed portion 140 is further recessed relative to the second recessed portion 142, such that the first recessed portion 140 and second recessed portion 142 may sometimes be referred to as being in a terraced arrangement relative to each other.

In some examples, in at least scan region 24, the outer wall 23 has a uniform height H1 extending between top edge 212A and bottom edge 214A.

As noted elsewhere, in some examples, the depth H5 of the first recessed portion 140 is no more than 110 percent to 130 percent of the height H1 of the outer wall 23 of the scan assembly frame 22.

In some examples, a distance H8 between the first bottom panel 147 and a bottom edge 214A of outer wall 23 identifies the extent to which the first recessed portion 140 extends vertically below and protrudes beyond the bottom edge 214A of outer wall 23 in at least the scan region. As noted elsewhere, in some examples, this protruding portion may extend downward into an interior of a printer frame (42 in FIG. 2) below the scan assembly frame 22. Meanwhile, in some examples, as further shown in FIG. 3B, a bottom edge 214B of the outer wall 23 of scan assembly frame 22 in at least the control region 26 is vertically below (e.g. extends beyond) a bottom edge 214A of outer wall 23 in at least the scan region 24.

In some examples, in a manner similar to border 157 in FIG. 3A, as further shown in FIG. 3B in some examples the interior frame portion 29 includes a border 257 defining a transition between the scan region 24 and the control region 26.

In some examples, the border 257 has a thickness H11. In some examples, this thickness H11 is less than a height H1 of the outer wall 23 of the scan assembly frame 22. In some examples, the border 257 has a top surface 258 which extends in generally the same plane as a top edge 212A of the outer wall 23.

However, in some examples, a top edge 258 of the border 257 is spaced apart (e.g. recessed) from the top edge 212A of the outer wall 23 by a distance no more than a thickness of the scan surface 131 extending over scan region 24.

In some examples, a bottom edge 259 of border 257 is spaced apart by a distance H12 from a bottom edge 214A of outer wall 23.

As previously noted in association with FIGS. 3A-3B, in some examples the control region 26 includes a third recessed portion 160 to at least partially house the control panel 110. In some examples, the third recessed portion 160 also houses and/or incorporates a pivot mechanism P by which a portion of the control panel 110 is mounted and by which the control panel 110 is pivotally movable into the upright position shown in FIG. 3D.

In some examples, the third recessed portion 160 includes a bottom panel 370. As shown later in association with at least FIG. 4, in some examples the bottom panel 370 is defined by a plurality of spaced apart struts 372A, 372B.

In some examples, a bottommost portion 374 of the bottom panel 370 of the third recessed portion 160 extends beyond (i.e. protrudes from) the bottom edge 214B of the outer wall 23 in at least the control region 26. This arrangement, in turn, enables a top surface 280 of control panel 110 to be flush with a top surface of adjacent covers (250A, 250B in FIG. 3D) for the outer portions 163A, 163B (FIG. 3A).

As shown in FIG. 3B, at side 27B of the scan assembly frame 22, the corresponding portion of outer wall 23 extends in third orientation (T), forming an acute angle (a) relative to a plane H, which is parallel to a bottom edge 214A of the outer wall 23 (in at least scan region 24).

With further reference to at least FIGS. 2, 3A, and 3B, in some examples a height H1 of the outer wall 23 is at least one order of magnitude less than a width W1 of the interior frame portion 29 between a side 27B (i.e. front portion adjacent control region 26) and the opposite side 27A (i.e. back portion adjacent first recessed portion 140) of scan assembly frame 22, 102.

With further reference to at least FIGS. 2, 3A, and 3B, in some examples the outer wall 23 has a height H1 at least one order of magnitude less than a length L1 of the scan assembly frame 22 between a first end 150A and an opposite second end 150B of the scan assembly frame 22.

In some examples, in at least the scan region 24, the interior frame portion 29 omits freestanding vertical walls or horizontally extending protrusions to enable free movement of scan unit 120 throughout substantially the entire length L1 and width W2 of the entire scan region 24.

In some examples, the scan unit 120 is sole active imaging component contained within scan region 22.

FIG. 4 is a perspective view schematically representing a scan assembly 300, according to one example of the present disclosure. In some examples, scan assembly 300 comprises at least some of substantially the same features and attributes as the scan assemblies 20, 100 as previously described in association with at least FIGS. 1-3D. As shown in FIG. 4, the scan assembly 300 comprises a monolithic metal frame 302, which in some examples comprises at least some of substantially the same features and attributes as frame 22 as previously described in association with at least FIGS. 1-3D.

The frame 302 has an outer wall 323 defining an interior frame portion 315, which has a scan region 324 and a control region 326. In a manner similar to FIGS. 3A, 3B, 4, the scan region 324 includes a first recessed portion 340 and a second recessed portion 342 having structural features and/or functionality substantially similar to first recessed portion 140 and second recessed portion 142 in FIGS. 3A-3B.

As further shown in FIG. 4, in some examples a first bottom panel 347 of the first recessed portion 340 comprises an elongate wall portion 350 and an elongate aperture 352 arranged in a generally parallel, side-by-side relationship. In some examples, the wall portion 350 comprises at least some of substantially the same features and attributes as first bottom panel 147 (FIGS. 3A-3B), except having aperture 352 along solid side wall portion 350. Accordingly, the wall portion 350 is sized and shaped to support a scan unit, such as scan unit 120 including a drive unit 126, scan bar 124, and guide 128 in a manner similar to that shown in FIGS. 3A-3B. Meanwhile, the elongate aperture 352 provides space to receive, and allow movement of, flexible circuitry and/or wiring associated with scan unit 120 as scan unit 120 travels the length of the scan region 324.

As further shown in FIG. 4, the second recessed portion 342 includes a second bottom panel 348, which is in some examples, is at least partially defined by a plurality 360 of spaced apart struts 362A, 362B. This arrangement provides strength without undue mass.

As further shown in FIG. 4, in some examples scan assembly frame 302 includes control region 326 having at least some of substantially the same features and attributes as control region 26 as previously described in association with at least FIGS. 3A-3D. With this in mind, control region 326 includes first recessed portion 360 including a bottom panel 370 formed as a plurality of struts 372A, 372B with first recessed portion 360 including a bottommost portion 374. Like first recessed portion 160 in FIGS. 3A-3D, the first recessed portion 360 is sized and shaped to at least partially house and support a control panel 110 such that control panel 110 is pivotally mounted relative to front edge 376. In some examples, bottommost portion 374 is sized and shaped to facilitate pivotal movement of a portion of a control panel 110 to enable maneuvering the control panel 110 into an upright position for easier user access, as shown in FIG. 3D.

With further reference to at least FIG. 4, in some examples the first recessed portion 360 (and mountable control panel 110) is interposed between outer portions 381A, 381B, which include each include a respective ledge 382A, 382B for at least partially supporting a respective cover (e.g. 250A, 250B in FIG. 3D) and include a respective aperture 383A, 383B.

In some examples, the wall portion 350 of the first bottom panel 347 may be at least partially defined by a plurality of spaced apart struts like struts 362A, 362B of second bottom panel 348.

As shown in FIG. 4, in some examples, the entire metal frame 302 is directly exposed, i.e. the metal frame 302 is not enclosed or otherwise covered by a layer of non-metal material, such as plastic. Moreover, in some examples, the metal frame 302 comprises the sole support member for components vertically above at least a portion of the metal frame 302. It will be understood, however, that metal frame 302 can be painted or powder-coated, which would still considered to be “directly exposed” because even with such coating, there is no plastic layer (or other non-metal material layer) covering the metal frame 302.

Via this arrangement, in some examples no non-metal covering (e.g. plastic support layer) is interposed between the metal frame 302 and the scan unit 120 and no non-metal covering (e.g. plastic support layer) is interposed between the metal frame 302 and a scan surface (e.g. 131 in FIG. 3C) on top of the metal scan assembly frame 302.

In some examples, internal components such as scan unit 120 are directly coupled to metal frame 302, such that no non-metal layer (e.g. plastic support layer) is interposed between the scan unit 120 and the scan region 324 of the metal frame 302. It will be understood that, in at least some examples, the term “directly coupled” does not exclude fasteners but indicates that a non-metal (e.g. plastic, etc.) sheet or other structure does not form a layer over the metal frame.

In some examples, the outer wall 323 is seamless such that at least an outer face 35 of the outer wall 323 defines a continuous surface lacking seams or other visible discontinuities.

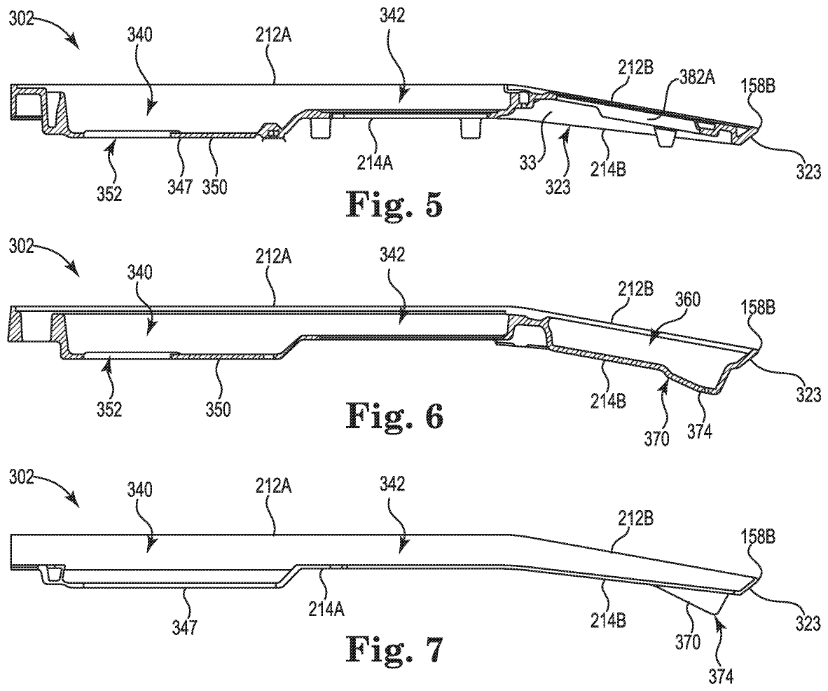

FIG. 5 is a sectional view of the scan assembly frame 302 of FIG. 4 as taken along lines 5-5, according to one example of the present disclosure. Accordingly, the scan assembly depicted in FIG. 5 is just one example of the scan assembly frame previously described in association with at least FIGS. 3A-3D. As shown in FIG. 5, the scan assembly 302 includes the first recessed portion 340 and second recessed portion 342. First bottom panel 347 of first recessed portion 340 includes wall portion 350 and aperture 352.

In one aspect, in the control region 326, FIG. 5 depicts outer portion 381A including ledge 382A and an inner face 33 of outer wall 323. Among other components, the ledge 382A at least partially supports a cover (e.g. 250A in FIG. 3D) mountable on top of outer portion 381A of control region 326.

FIG. 6 is a sectional view of the scan assembly of FIG. 4 as taken along lines 6-6, according to one example of the present disclosure, with FIG. 6 including at least some of substantially the same features and attributes as described in association with FIGS. 4-5. Accordingly, the scan assembly depicted in FIG. 6 is just one example of the scan assembly frame previously described in association with at least FIGS. 3A-3D. As shown in FIG. 6, in some examples the control region 326 includes the third recessed portion 370 to at least partially receive and house a control panel, such as control panel 110 (FIGS. 2-3B). In one aspect, the third recessed portion 360 is sized and shaped to accommodate the size and shape of the control panel 110 to result in, in at least one of the pivotal positions of the control panel 110, a top surface of the control panel 110 to be flush with (i.e. at the same level as) top edge 212B of the outer wall 323 in at least control region 326 and/or flush with other top surface of covers 250A, 250B (FIG. 3D) of outer portions 381A, 381B of control region 326 in FIG. 4.

FIG. 7 is an end view of the scan assembly of FIG. 4 as taken along lines 7-7, according to one example of the present disclosure, with FIG. 7 including at least some of substantially the same features and attributes as described in association with FIGS. 4-6. As shown in the end view of FIG. 7, a bottom panel 347 of first recessed portion 340 extends beyond (e.g. vertically below) a bottom edge 214A of the outer wall 323 of scan assembly frame 302 in at least the scan region 324. In another aspect, a bottommost portion 374 of third recessed portion 360 extends beyond (e.g. vertically below) a bottom edge 214B of the outer wall 323 of scan assembly frame 302 in at least the control region 326.

FIG. 8 is a diagram schematically representing a multi-function imaging device 440, according to one example of the present disclosure. In some examples, the imaging device 440 comprises at least some of substantially the same features and attributes as imaging device 40, as previously described in association with at least FIG. 2, except including a different printer frame 442. In some examples, the printer frame 442 includes a first portion 446 and a cantilevered second portion 447 with dashed lines 448 denoting a boundary between the two respective portions 446, 447.

In some examples, first portion 446 has a width W5 and height H15, while second portion 447 has a width W6 and a height (e.g. thickness) H14. The overall height of printer frame 442 is represented as H2.

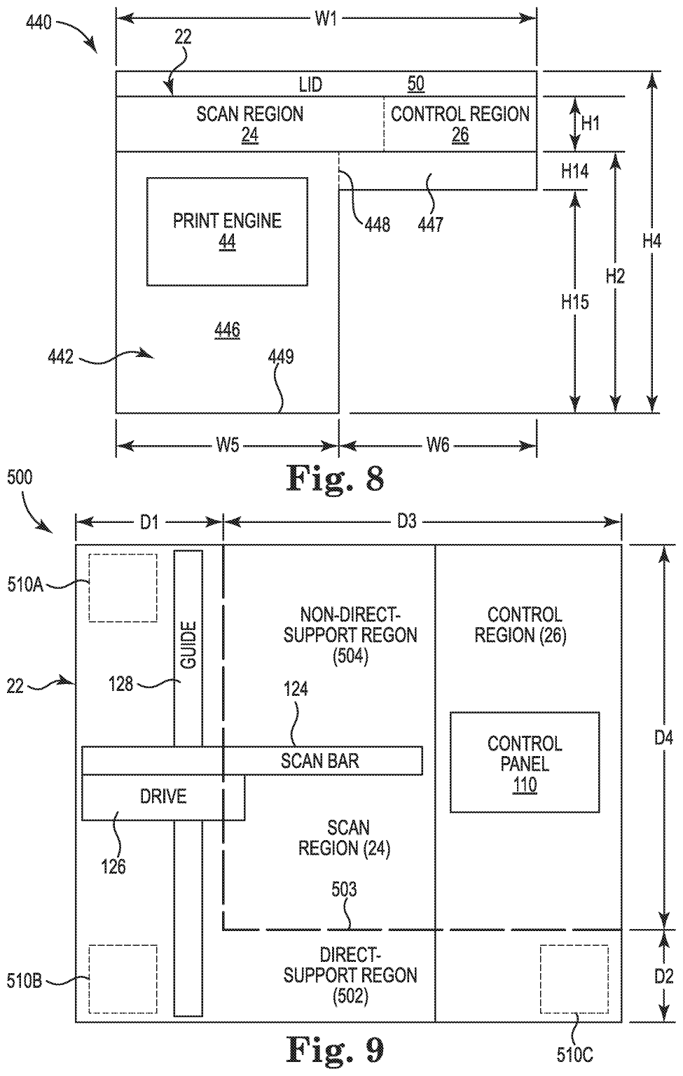

Via this arrangement, the imaging device includes a direct support region 502 and a non-direct support region 504 as shown in FIG. 9, according to one example of the present disclosure.

FIG. 9 provides a graphic representation of a support layout 500 juxtaposed relative to the components of the scan assembly 100 (FIG. 3A) to demonstrate the direct support region 502 and the non-direct-support region 504. In some examples, in the direct support region 502 shown in FIG. 9, the first portion 446 of printer frame 442 provides direct vertical support from a surface (e.g. floor or desktop) independent of the imaging device up to and through the second frame. Stated differently, the direct support region 502 represented in layout 500 in FIG. 9 corresponds to those portions of the scan assembly frame 22 for which direct vertical support is provided via a print frame 442 positioned below the scan assembly frame 22, as shown in FIG. 8.

In the non-direct support region 504 shown in FIG. 9, the scan assembly frame 22 receives vertical support via the cantilevered second portion 447 of the first frame 442, which extends horizontally from the first portion 446 of first frame 442, as shown in FIG. 8. At least a portion of the non-direct support region 504 is co-extensive with at least a portion of the control region 26 as shown in FIG. 9. Accordingly, the control region 26 can be supported via a cantilevered arrangement, which can enable unique configurations of a scan assembly frame 22 (to house a scan unit) relative to a first frame 442, which houses a print engine. In one aspect, the monolithic metal construction of the scan assembly frame 22 provides the strength and rigidity to implement the cantilevered arrangement.

In some examples, at least a portion of the non-direct-support region 504 is co-extensive with at least a portion of scan region 24, as shown in FIG. 9.

Accordingly, as shown via FIGS. 8-9, the non-direct-support region 504 corresponds to those portions of the scan assembly frame 22 for which direct vertical support is not present.

With further reference to FIG. 9, in some examples in the direct support region 502, the printer frame 442 includes several columns 510A, 5106, 510C, with columns 510A, 5106, and 510C at least partially defining first portion 446 of the printer frame 442 shown in FIG. 8. In contrast, in the non-direct-support region 504 of layout 500, no similar vertical-support columns are present. Instead, scan assembly frame 22 is supported via cantilevering by second portion 447 of printer frame 442, as previously mentioned above.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A scan assembly comprising:
a monolithic metal frame having an outer wall defining an interior frame portion having:
a scan region to support and at least partially house a scanning unit to be movable within and relative to the scan region; and
a control region to support and at least partially house a control panel,
wherein the outer wall has a first face exposed to the interior frame portion and an opposite second face directly exposed to an external environment.

2. The scan assembly of claim 1, wherein, adjacent at least the scan region, a height of the outer wall extends in a first orientation and at least a majority of the scan region extends in a second orientation generally perpendicular to the first orientation.

3. The scan assembly of claim 1, wherein the monolithic frame is a die-cast single unitary piece.

4. The scan assembly of claim 1, wherein the height of the outer wall is less than a thickness of the movable scan unit.

5. The scan assembly of claim 1, wherein the interior frame portion defines a border portion between the scan region and the control region with the border portion having a thickness no more than a height of the outer wall.

6. The scan assembly of claim 1, wherein the interior frame portion is directly exposed to the scan unit and the control unit, and wherein the interior frame portion is directly connectable to the scan unit and the control unit.

7. The scan assembly of claim 1, comprising a scan surface mounted at the top edge of the outer wall and extending in the second orientation over the scan region, wherein the scan surface is sized to enable the document to remain in a fixed location during scanning via movement of the scan unit relative to the scan region of the interior frame portion.

8. The scan assembly of claim 1, wherein the scan assembly forms part of an imaging device including a printer having a second frame on which the scan assembly is mounted.

9. The scan assembly of claim 1, wherein the control region has a recessed portion into which at least a portion of the control panel is rotatably receivable, and wherein a bottom portion of the recessed portion extends vertically below a bottom edge of the outer wall in at least the control region.

10. An imaging device comprising:
a first frame to at least partially house a print engine; and
a second frame vertically supported by the first frame, the second frame being a monolithic metal frame including an outer wall defining an interior frame portion including:
a scan region to support and at least partially house a scanning unit to be movable within and relative to the scan region; and
a control region to support and at least partially house a control panel,
wherein the outer wall includes a first face exposed to the interior frame portion and an opposite second face directly exposed to environment external to the imaging device.

11. The imaging device of claim 10, comprising:
a direct support region in which the first frame includes a first portion to provide direct vertical support from a surface independent of the imaging device up to and through the second frame; and
a non-direct support region in which the second frame receives vertical support via a cantilever second portion of the first frame, which extends horizontally from the first frame,
wherein at least a portion of the non-direct support region is co-extensive with the control region of the interior frame portion.

12. The imaging device of claim 10, wherein the interior frame portion is directly exposed to the scan unit and the control unit, and wherein the interior frame portion is directly connectable to the scan unit and the control unit.

13. The imaging device of claim 10, wherein the scan region of the interior frame portion includes a first recessed portion which extends beyond a bottom edge of the outer wall to extend into an interior space defined by the first frame.

14. A scan assembly for an imaging device comprising:
a single unitary metal frame defining:
an outer wall to be directly exposed to an external environment and having a height at least one order of magnitude less than a length and a width of the metal frame; and
an interior portion having a first region to support a movable scan unit and second region to support a control panel, wherein the first region and the second region are in a side-by-side relationship.

15. The scan assembly of claim 14, wherein the first region has a first recessed portion extending beyond a lower edge of the outer wall and within which the scan movable scan unit is at least partially housed, and with an upper portion of the scan unit not extending vertically beyond a top edge of the outer wall.
